(19) United States
(12) Patent Application Publication
(10) Pub. No.: US 2008/0151836 A1
(43) Pub. Date: Jun. 26, 2008

(54) PORTABLE DEVICE AND COMMUNICATION SYSTEM THEREOF

(75) Inventor: Toshihiro MOROHOSHI, Kanagawa (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/775,911

(22) Filed: Jul. 11, 2007

(30) Foreign Application Priority Data
Dec. 25, 2006 (JP) 2006-347608

(51) Int. Cl. H04Q 7/00

(52) U.S. Cl. 370/331

(57) ABSTRACT

Access points are stationed in stores, a service provider is connected to the access points, a service provider is connected to the access point (AP). For example, when a user carrying a PD (portable device) enters within communication range of the AP, a communication starts between the PD and the AP. if network IDs of the PD and the AP coincide with each other, the network ID is stored in a memory portion of the PD, an application program corresponding to the network ID automatically starts up, and an information corresponding to the application is indicated on the display.

This application is based on Japanese patent application No. 2006-347608, the entire contents of which are incorporated herein by reference.

### BACKGROUND OF THE INVENTION

1. Field of the Invention

The present invention relates to a portable device of recording and playing back a music and an image, and a portable device to have a communication function to be connected to a network, and relates to a communication SYSTEM thereof.

2. Description of the Related Art

As a low power in semiconductor device, a high capacity in a semiconductor memory and a battery, etc. progress, many kinds of a battery-operated network terminal device (portable device) are developed. For example, a cellular telephone, a portable memory device, an audio player, a DVD player, etc. are commercialized.

Some portable devices are equipped with a wireless LAN (Local Area Network) for communicating with another electronics device. In a wireless LAN, in order to distinguish one wireless network from another, a communication using a header of a communication frame including a characteristic identification code is conducted, and participation in the network shall be permitted, when an authentication between an access point (AP) and a portable device is implemented.

A hand over method is known in a wireless LAN based on IEEE 802.11 standard for example. According to the hand over method, whether or not to permit a portable terminal device to participate in the network using network ID called BSS (Basic Service Set)-ID is decided, after participation, BSS-ID should not be assigned repeatedly to a plurality of APs, a series of protocol processings (withdrawal from network, participation, authentication, re-participation, etc.) accompanied with hand over is conducted not to interrupt a communication, after transfer to a next AP, another BSS-ID is transmitted from the next AP to the portable terminal device responding to a request for hand over from a former AP (for example, refer to Japanese patent kokai No. 2006-270665).

However, according to a conventional portable device, even if the hand over method is employed, it is impossible to obtain specific information or service relevant to a AP, because network ID decides whether or not to permit connection between AP and a portable terminal device portable device)

### BRIEF DESCRIPTION OF THE SEVERAL VIEWS OF THE DRAWING

A general configuration that implements the various features of the invention will now be described with reference to the drawings. The drawings and the associated descriptions are provided to illustrate embodiments of the invention and not to limit the scope of the invention.

FIG. 1 is an exemplary schematic diagram showing a connection of a portable devise communication system according to the first embodiment of the present invention;

FIG. 2 is an exemplary schematic view showing an exterior appearance of the portable device;

FIG. 3 is an exemplary block diagram showing a system configuration of the portable device;

FIG. 4 is an exemplary chart showing configuration of a table stored in the memory portion;

FIG. 5 is an exemplary schematic diagram showing an example of a screen appeared on the display;

FIG. 6A is an exemplary flow chart showing an explanation of the process of the control portion; and

FIG. 6B is an exemplary flow chart for explaining the process according to the second embodiment of the present invention.

### DETAILED DESCRIPTION OF PREFERRED EMBODIMENTS

Various embodiments according to the invention will be described hereinafter with reference to the accompanying drawings. In general, according to one embodiment of the invention, there is provided a portable device, including: a communication means for being connected via wireless system to an access point; a memory portion for storing application programs which start up with reference to a predetermined network ID of the access point; and a control portion for starting up at least one of the application programs stored in the memory portion by obtaining the network ID from the access point via the communication means in a communication range of the access point.

In addition, according to a further embodiment of the invention, there is also provided a portable device, including: a communication means for being connected via wireless system to an access point; a memory portion for storing application programs which start up with reference to a predetermined network ID of the access point; and a control portion for starting up at least one of the application programs stored in the memory portion by obtaining the network ID from the access point via the communication means in a communication range of the access point, and for quitting the application programs out of the communication range of the access point.

According to the above-mentioned configuration, when the portable device is within the communication range of the access point, and the network ID obtained from the access point corresponds to the network ID in the memory, an application program corresponding to the network ID is started up and obtain specific information from the access point.

In addition, according to a still further embodiment of the invention, there is provided a communication system of a portable device, including: an access point; a service provider connected to the access point; and a portable device for obtaining a network ID within communication range of the access point, and starting up at least one of application programs in accordance with the network ID.

According to the above-mentioned configuration, if the portable device is within communication range of the access point, it is possible to communicate each other, in case where the network ID received from the access point exists in the portable device, application program corresponding to the network ID started up, so that it is possible to obtain specific information corresponding to the access point.

According to the present invention, it is possible to obtain specific information or service corresponding to a network ID from the access point stationed in a service of a service delivery station.

### The First Embodiment

### (Configuration of the Communication System)

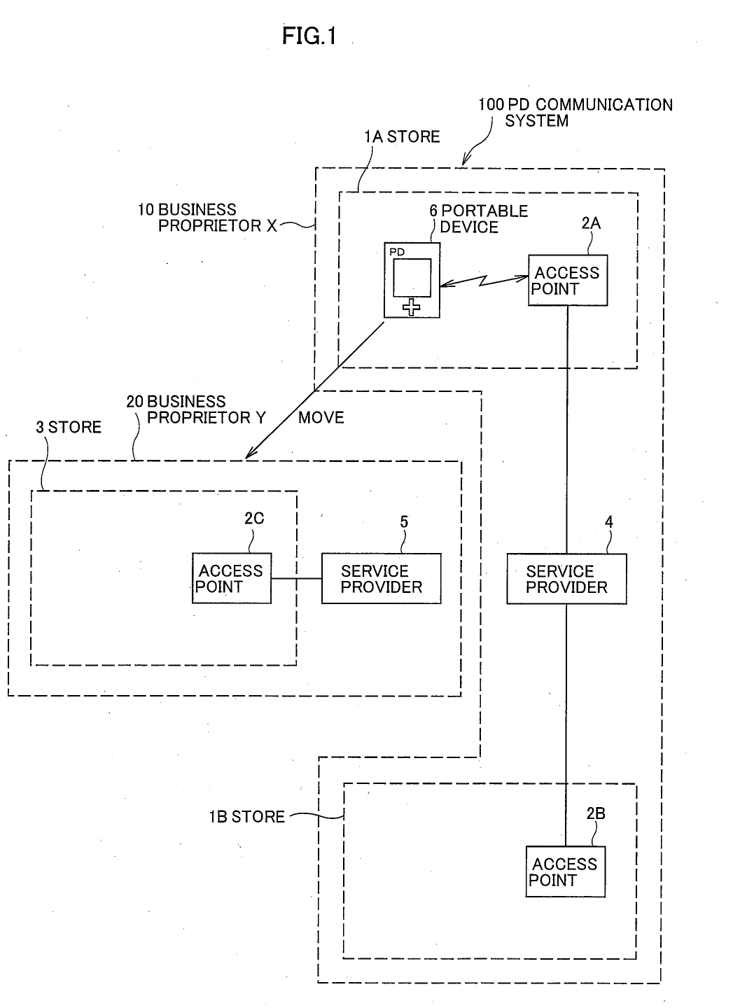

FIG. 1 is an exemplary schematic diagram showing a connection of a portable devise communication system according to the first embodiment of the present invention. PD communication system 100 includes access points (APs) 2A and 2B stationed in stores 1A and 1B which a business proprietor X 10 of a service delivery station owns, an AP 2C stationed in a store 3 which a different business proprietor Y 20 with the business proprietor of the stores 1A and 1B of a service delivery station owns, a service provider 4 connected to the AP 2A, the AP 2B and a service provider 5 connected to the AP 2C, and the PD 6 carried with a user as a customer for the stores 1A to 1C.

The stores 1A, 1B and 3 are, for example, convenience stores, mass consumer-electronics retailers, chain stores and the like. In this embodiment, number of the stores are 3, and number of the service providers are 2. However, number of the stores and number of the providers are not limited.

The APs 2A and 2B are network terminal devices which are stationed in the stores 1A and 1B and have one or more interface which is connected to the PD 6 and the service provider 4 such as wireless LAN, Bluetooth, telephone network (cellular phone), ZigBee, and the like.

The AP 2C is a network terminal device stationed in a store 3 and have one or more interface which is connected to the PD 6 and the service provider 5 such as wireless LAN, Bluetooth, telephone network (cellular phone), ZigBee, and the like. For example, a personal computer having function of wireless LAN can be used as the APs 2A to 2C.

The service providers 4 and 5 are servers connected to the Internet (not shown). The service provider 4 is connected to the APs 2A and 2B and the service provider 5 is connected to the AP 2C.

### (Appearance of PD)

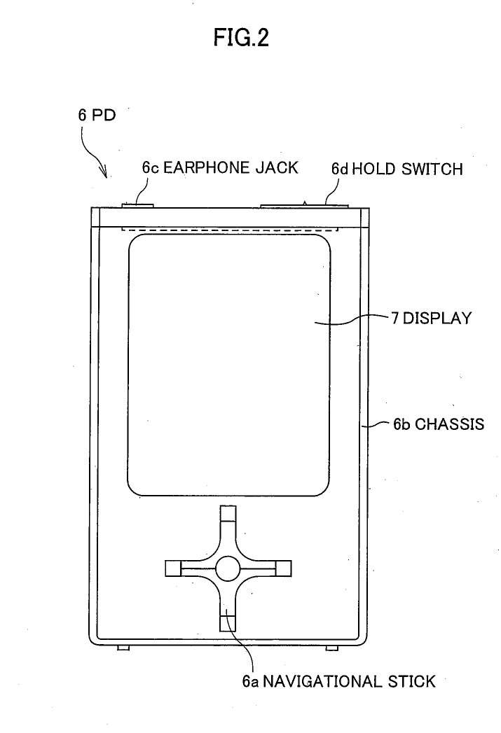

FIG. 2 is an exemplary schematic view showing an exterior appearance of the portable device. The PD 6 includes, for example, a digital media player, a cellular phone, a PDA (Personal Digital Assistant) and the like. In this embodiment the PD 6 is a digital media player. The PD 6 have a communication function, which respond when the power of the PD 6 is on and the PD 6 is in a predetermined distance (for example within 30 meter) from any of the APs 2A to 2C, such as wireless LAN, telephone network, ZigBee, and the like.

The PD 6 comprises a LCD display 7 and a navigational stick (arrow key) 6a in front face of a enclosure 6b, an earphone jack 6c and a hold switch 6d in upper side face of the enclosure 6b, a power on/off switch (not shown), a volume lever (not shown), and the like in right-and-left side face of the enclosure 6b.

The display 7 is, for example, a TFT color liquid crystal display whose size is 3.5 inch, and whose screen resolution is 320×260 dots.

### (System Configuration of PD)

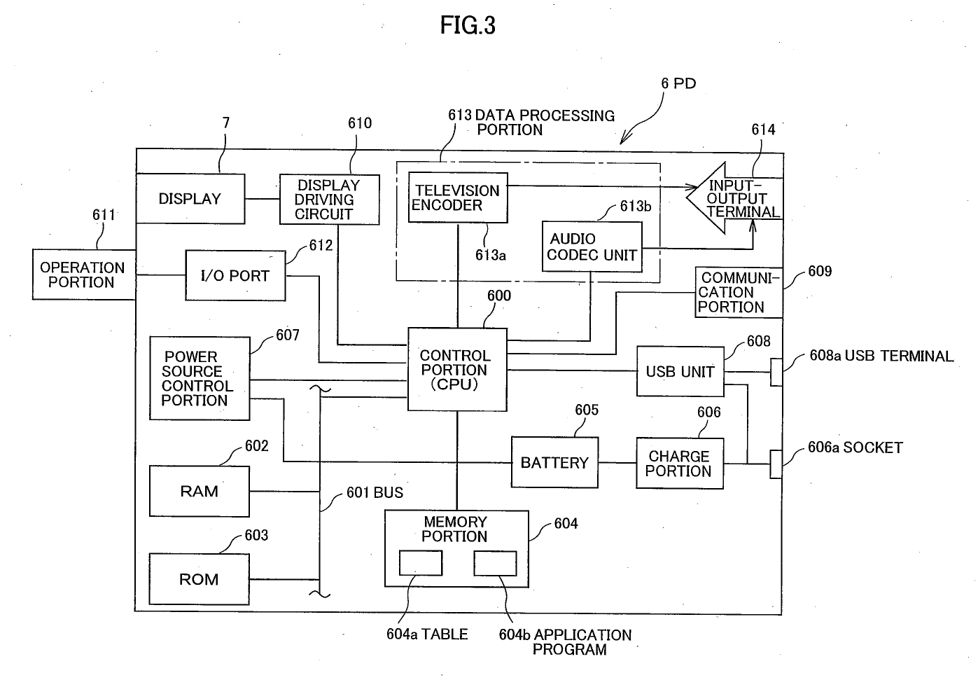

FIG. 3 is an exemplary block diagram showing a system configuration of the portable device the PD 6 comprises a control portion 600 constited of CPU, a bus 601 connected to the control portion 600, a RAM 602 and ROM 603 connected to the bus 601, a memory portion 604 storing audio data and image data, a battery 605 as a power source, a charge portion 606 charging up the battery 605 by power supply from a socket 606a, a power source control portion 607 controling the power supply from battery 605 to CPU, and the like, USB (Universal Serial Bus) unit 608 providing transmission of data for an electronics device connected to USB terminal 608a in conformity with USB standard, a communication portion 609 communicating with access point (AP), a display driving circuit 610 driving the display 7, an operation portion 611 operated by user, an I/O port 612 connecting the operation portion 611 with the power source control portion 607, a data processing portion 613 processing audio data and image data, and an input-output terminal 614 connecting the data processing portion 613 with an external device.

The ROM 603 is a nonvolatile memory which stores programs operating the PD 6.

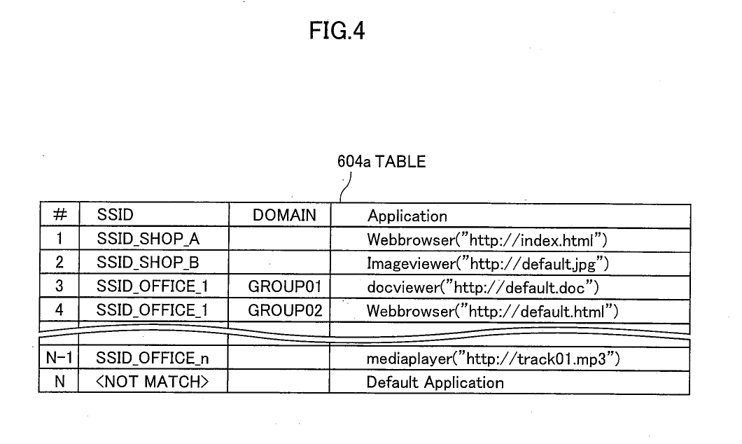

The memory portion 604 comprises, for example, a hard disk drive (HDD), and stores a table 604a shown in FIG. 4, various application programs, and various data.

The data processing portion 613 comprises a television encoder 613 processing image data such as a television broadcast, and the like, read from the memory portion 604, and outputing a resulting image data to the input-output terminal 614, and an audio CODEC unit 613b processing audio data read from the memory portion 604, and outputting a resulting audio data to the input-output terminal 614. Digitilized video data and audio data are inputted from the input-output terminal 614.

Here, the operation portion 611 includes the navigational stick 6a, the hold switch 6d, the power switch, and the volume lever as shown in FIG. 2.

### (Configuration of Table)

FIG. 4 is an exemplary chart showing configuration of a table stored in the memory portion. The table 604a consists of N pieces of segments titled from #1 to #N, each segment consists of 3 types of SSID (Service Set IDentifier) as network ID, a domain, and an application program.

In case, there are a number of business tie-up stores such as, for example, convenience stores and all the stores provide a network access using a common service provider, a SSID which is set in each stores is identical in general, but a different domain name shall be set in a different store. For example, the domain name is got through gateway address of network.

It is possible to employ a method for storing the table 604a as a configuration file of the PD 6. In this case, the PD 6 is, for example, connected to a personal computer via USB or network and download a data related with the table 604a, so that the table 604a is updated.

At #3 and #4 in the table 604a, an application program being started up shall be defined referring a pluarity of SSIDs.

### (Operation of PD Communication System)

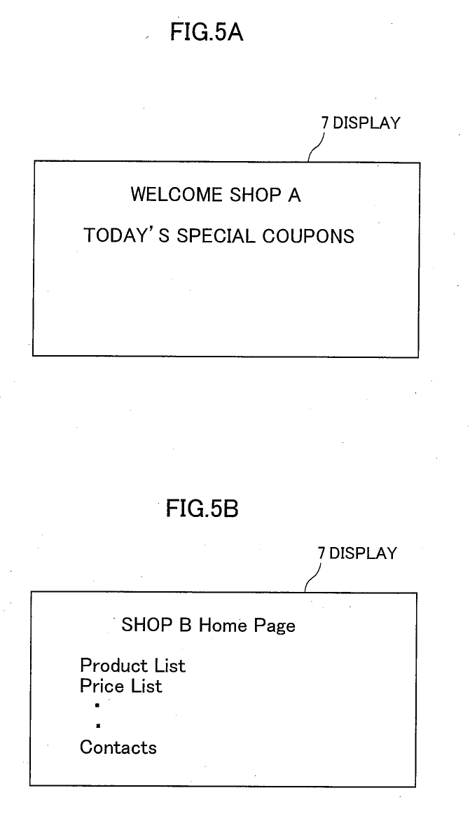

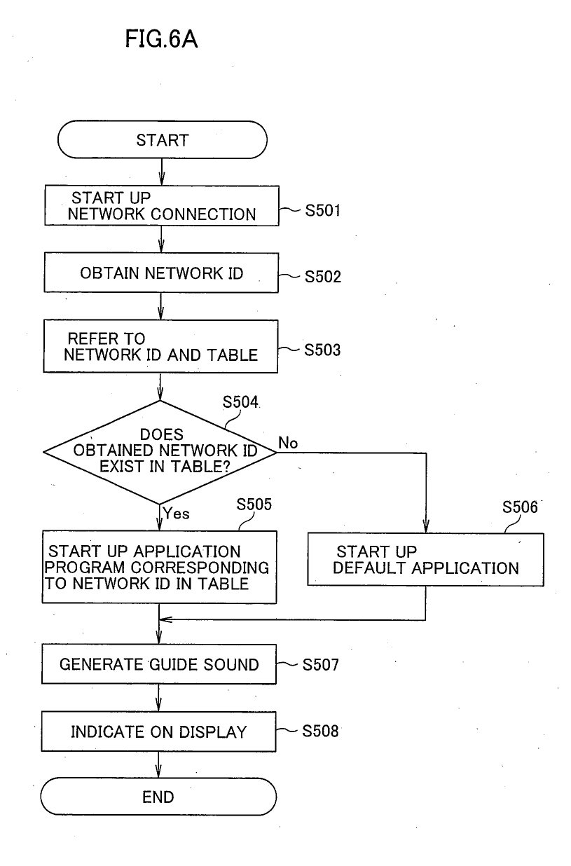

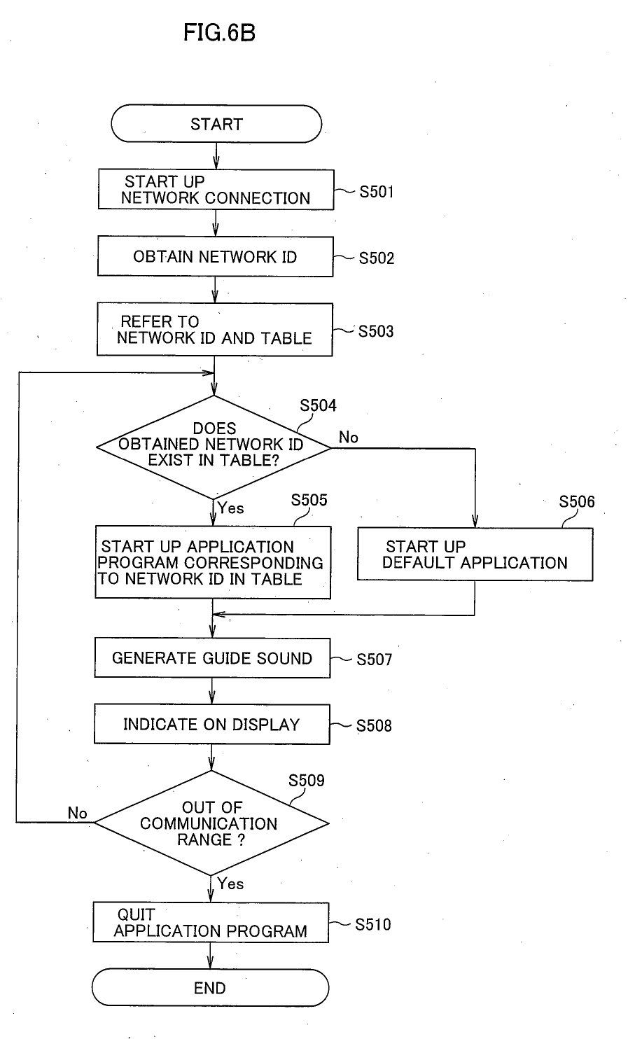

FIG. 5 is an exemplary schematic diagram showing an example of a screen appeared on the display. FIG. 5A is a exemplary schematic diagram showing a view corresponding to the store 1A shown. FIG. 5B is a exemplary schematic diagram showing a view corresponding to the store 3. FIG. 6A is an exemplary flow chart showing an explanation of the process of the control portion. Referring to FIG. 1 to FIG. 6A, an operation of the PD communication system 100 will be explained below.

Here, a user is away from home carrying with the PD 6, and the PD 6 is, for example, powered on for listening to music. When the user comes near the store 1A shown in FIG. 1 and enters within a communication range of the AP 2A, the PD 6 receives radio wave emitted from the AP 2A via the communication portion 609, and starts connecting to AP 2A.

Here, the connection between the AP 2A to the AP 2C and the PD 6 can start without an authentication of a network ID (a SSID). However, in some cases, when the authentication of a SSID is unrecognized, the connection is impossible. When the authentication is unrecognized, the process shown in FIG. 6A does not start.

If the connection between the AP 2A and the PD 6 is recognized, the process shown in FIG. 6A starts (S501). The PD 6 obtains a network ID (a SSID) from the AP 2 (S502). Next, the control portion 600 shown in FIG. 3 refers the table 604a shown in FIG. 4 (S503), and decide whether or not the SSID informed from the AP 2A exists in the table 604a (S504). If the SSID informed from the AP 2A exists in the table 604a YES in S504), the control portion 600 starts up the application program corresponding to the SSID (S505).

If a SSID informed from the AP 2A corresponds to, for example, “SSID SHOP A” shown in FIG. 4, the control portion 600 starts up an application program of web browser “http://index.html”, operates the display driving circuit 610 and displays an image shown in FIG. 5A on the display 7 in stead of an image displayed till then on the display 7 (S508).

After the application program starts up in the step of S505, the control portion 600 generates a guide sound such as a beep sound or a melody (S507). This function can be stopped by a user's selection. Constitution of the software can not have the function described in the step of S507. Even if the PD 6 is carried in a pocket or a bag, and the like, the user has a chance to become aware of incoming call-out and to watch the display 7 through the process in the step of S507. If the user has the PD 6 in the user's hand, the user can immediately watch the display 7.

The web browser shown in FIG. 5. is indicated on the display 7, thereby, for example, if the user carrying the PD 6 walks or moves near the store 1A, it is expected that the user watches contents indicated on the display 7, takes an interest in contents, and enters in the store 1A. That is, the automatic connection between the AP 2A and the PD 6 can lead the user to the store 1A.

In the step of S504, if a SSID corresponding to the table 604a does not exist (S504, NO), the connection between the AP 2A and the PD 6 is disconnected, a default application of #N in the table 604a is started up (S506) and the process comes to an end.

Next, if a user carrying the PD 6 gets away from the store 1A and moves near another store 3, the PD 6 receives radio wave from the AP 2C via wireless LAN in the same way as described in the store 1A. If the PD 6 receives radio wave from the AP 2C, the PD 6 starts the process explained in FIG. 6A.

If a SSID informed from the AP 2C exists in the table 604a (S504, YES), the control portion 600 starts up the application program corresponding to the SSID (S505). If the SSID is, for example, “SSID SHOP B”, an image viewer “http://default.jpg” shown in table 6 of FIG. 4 starts up, a screen shown in FIG. 5B is indicated on the display 7 (S508). Watching a screen on the display 7 of PD 6, a user can get into desired action.

### Effect of the First Embodiment

According to the first embodiment of the present invention described above, the PD 6 can get a specific information corresponding to each AP by obtaining a SSID. That is, when the PD 6 enters within communication range of any of the AP 2A to 2C stationed in the store 1A, 1B and 3, an application program in the PD 6 automatically starts up by checking a network ID, so that massages can be transmitted to the user carrying the PD 6.

### The Second Embodiment

FIG. 6B is an exemplary flow chart for explaining the process according to the second embodiment of the present invention.

The configuration of a PD 6 and a PD communication system 100 according to the present embodiment is the same as the first embodiment shown in FIG. 1 to FIG. 4 except for the step in the PD 6. That is, the process after the PD 6 moves out of the communication range are added after the process of S508 in FIG. 6A as shown in FIG. 6B.

The process of FIG. 6B is similar to the process of FIG. 6A. When the PD 6 carried by a user enters within the communication range of the AP 2A shown in FIG. 1 (S501), the PD 6 gets a SSID from the AP 2A (S502), judges whether or not the SSID informed from the AP 2A exists in the table 604a (S502, S504), If the SSID exists in the table 604a S504, YES), the control portion 600 starts up the application program corresponding to the SSID (S505), and the display 7 is driven by operation of the application program (S508).

After the step of S505, the control portion 600 judges whether or not the PD 6 exists within communication range of the AP 2A (S509). In case, the PD6 is out of the communication range (S509, YES), the application program started up in the step of S505 is quit (S510). In this case, the control portion 600 deletes data such as music data easily copied which the PD 6 has got from the AP 2A. When a coupon shown in FIG. 5A was not used, the data corresponding to the coupon from the store 1A may be deleted automatically.

Afterward, the process from the step of S501 to the step of S510 described above runs repeatedly, whenever the PD 6 is close to an AP in another store.

According to the second embodiment of the present invention described above, it is possible to have the same effect as the first embodiment, in addition, the data provided from a specific service provider can be deleted automatically, so that it is possible to protect the provided data from unauthorized use.

### Other Embodiment

The present invention is not limited to the above-described first and second embodiments, and can be variously modified without departing from the spirit and scope of the invention. For example, the language on a screen shown in FIG. 5 is English, but a pluarity of language including Japanese and so on can be indicated simultaneously or alternately.

Voice Message produced by voice synthesis, and the like, can be made an announcement at the same time of indicating message on the display 7 or instead of indicating message.

What is claimed is:

1. A portable device, comprising:
a communication means for being connected via wireless system to an access point;
a memory portion for storing application programs which start up with reference to a predetermined network ID of the access point; and
a control portion for starting up at least one of the application programs stored in the memory portion by obtaining the network ID from the access point via the communication means in a communication range of the access point.

2. A portable device according to claim 1, wherein
the memory portion stores a table having domains and application programs corresponding to the network ID,
the control portion starts up at least one of the application programs in accordance with the table.

3. A portable device according to claim 1, wherein
the network ID is a Service Set IDentifier (SSID).

4. A portable device according to claim 1, wherein
the control portion starts up at least one of the application programs, subsequently indicates information corresponding to at least one of the application programs on a display.

5. A portable device according to claim 1, wherein
the control portion authenticates a function of starting up at least one of the application programs.

6. A portable device, comprising:
a communication means for being connected via wireless system to an access point;
a memory portion for storing application programs which start up with reference to a predetermined network ID of the access point; and
a control portion for starting up at least one of the application programs stored in the memory portion by obtaining the network ID from the access point via the communication means in a communication range of the access point, and for quitting the application programs out of the communication range of the access point.

7. A portable device according to claim 6, wherein
the control portion deletes a data obtained from the access point out of communication range of the access point.

8. A portable device according to claim 6, wherein
the memory portion stores a table having domains and application programs corresponding to a network ID,
the control portion starts up at least one of the application programs in accordance with the table.

9. A portable device according to claim 6, wherein the network ID is a SSID.

10. A portable device according to claim 6, wherein
the control portion starts up at least one of the application programs, subsequently indicates information corresponding to at least one of the application programs on a display.

11. A portable device according to claim 6, wherein
the control portion authenticates a function of starting up at least one of the application programs.

12. A communication system of a portable device, comprising:
an access point;
a service provider connected to the access point; and
a portable device for obtaining a network ID within communication range of the access point, and starting up at least one of application programs in accordance with the network ID.

13. A communication system of a portable device according to claim 12, wherein
the portable device stores a table having domains and application programs corresponding to the network ID, and starts up at least one of the application programs in accordance with the table.

14. A communication system of a portable device according to claim 12, wherein
the network ID is a SSID.

15. A communication system of a portable device according to claim 12, wherein
the portable device quits the application programs started up out of communication range of the access point.

16. A communication system of a portable device according to claim 12, wherein
the portable device deletes a data obtained from the access point out of communication range of the access point.

17. The communication system of a portable device according to claim 12, wherein
the service provider connects to access points in units of an industry or an enterprise.

18. A communication system of a portable device according to claim 17, wherein
access points include plurality thereof and are stationed in a plurality of services such as an industry or an enterprise and the like.
